(19) United States
(12) Patent Application Publication
(10) Pub. No.: US 2007/0202307 A1
(43) Pub. Date: Aug. 30, 2007

(54) RIGID FLEXIBLE PRINTED CIRCUIT BOARD HAVING OPENINGS

(75) Inventors: Byoung-Ha OH, Gyeonggi-do (KR); Jong-Hoon KIM, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggid-do (KR)

(21) Appl. No.: 11/565,869

(22) Filed: Dec. 1, 2006

(30) Foreign Application Priority Data
Feb. 27, 2006 (KR) 2006-18550

(51) Int. Cl. B32B 3/00

(52) U.S. Cl. 428/209; 428/210; 428/901

(57) ABSTRACT

Disclosed herein is a rigid flexible PCB having openings. The rigid flexible PCB includes a flexible section with flexibility and rigid sections being formed at the edges of the flexible section with mechanical stiffness. The flexible section comprises a flexible plane. The flexible plane comprises a base insulating layer; a wire conducting layer being adhered to one of the top side and the bottom side of the base insulating layer; and a plane conducting layer adhered to the other of the top side and the bottom side of the base insulating layer. The plane conducting layer has a plurality of openings being formed as a mesh structure. According to the rigid flexible PCB of the invention, the flexibility of the flexible section and the characteristic impedance of signal wire traces may be improved.

### CROSS-REFERENCE TO RELATED APPLICATION

This application claims priority under 35 U.S.C. § 119 from Korean Patent Application No. 2006-18550 filed on Feb. 27, 2006, the contents of which are incorporated herein by reference in their entirety.

### BACKGROUND

1. Technical Field

The disclosure relates, in general, to a PCB (Printed Circuit Board) and, more particularly, to a Rigid Flexible PCB.

2. Description of the Related Art

A PCB is used for connecting various mounted electrical components with wire traces. In this case, it is very important to match the characteristic impedance of the wire traces with the input impedance of the mounted electrical components. Since the input impedance of the mounted electrical components is designed to be low, the characteristic impedance of the wire traces is desired to be low as well.

Meanwhile, a PCB capable of mounting components with high density is desired, due to the miniaturization of electronic products. According to such demand, various shaped PCBs are developed, and one of them is a rigid flexible PCB.

FIG. 1 is a cross-sectional view of a conventional rigid flexible PCB. FIG. 1 shows a cross sectional view along a vertical axis of a PCB. In FIG. 1, the wire conducting layer 22 and a plane conducting layer 23 are further illustrated in perspective views. As shown in FIG. 1, the rigid flexible PCB is consisted of rigid sections ARG1, ARG2 and a flexible section AFL. Since the rigid sections ARG1, ARG2 contain a prepreg 11, the mechanical stiffness of the rigid sections ARG1, ARG2 may be maintained. Also, The rigid sections ARG1, ARG2 contain a multiple conducting layer 13. In the multiple conducting layer 13, a main circuit is arranged. The flexible section AFL includes a base insulating layer 21. The base insulating layer 21 is formed as a polyimide layer for flexibility. The top side of the base insulating layer 21 is adhered with a wire conducting layer 22. In the wire conducting layer 22, the wire traces are arranged for transferring a power voltage VCC and signals. The bottom side of the base insulating layer 21 is adhered with a plane conducting layer 23 for transferring a ground voltage VSS. Through the wire conducting layer 22 and a plane conducting layer 23, it is possible for signals to be transferred between the rigid sections ARG1, ARG2.

However, in the conventional rigid flexible PCB, the bottom conducting layer 23, as shown in FIG. 1, is a simple planar form. That is to say, the whole of the bottom conducting layer 23 is covered with a conducting material. In this case, if a thickness t1 of the base insulator 21 is thin, the parasitic capacitance between the wire conducting layer 22 and the plane conducting layer 23 increases, and the characteristic impedance of signal wire traces is deteriorated. As a result, there is input impedance mismatching between signal wire traces and mounted components, so that it is difficult to improve the transfer characteristic. On the other hand, if a thickness t1 of the base insulating layer 21 is thick, the characteristic impedance of signal wire traces may be improved. However, there is a problem that the flexibility of the flexile section is deteriorated.

Thus, in the conventional rigid flexible PCB, it is difficult to improve flexibility of the flexible section and a characteristic impedance of signal wire traces at the same time.

### SUMMARY

An object of the invention is to provide a rigid flexible printed circuit board having openings. In order to accomplish the above object, there is provided a rigid flexible printed circuit board. The rigid flexible printed circuit board includes a flexible section and rigid sections being formed at the edge of the flexible section. The flexible section comprises a flexible plane. The flexible plane comprises a base insulating layer; a wire conducting layer being capable of having wire traces to transfer signals between the rigid sections, a wire conducting layer being adhered to one of the top side and the bottom side of the base insulating layer; and a plane conducting layer being adhered to the other of the top side and the bottom side of the base insulating layer, the plane conducting layer for transferring a reference voltage between the rigid sections. The plane conducting layer has a plurality of openings being formed as a mesh structure. The openings minimize the capacitive coupling between the wire conducting layer and the plane conducting layer, thereby decreasing the characteristic impedance of the wire traces while simultaneously allowing for a thin base insulating layer to improve flexibility.

### BRIEF DESCRIPTION OF THE DRAWINGS

The above and other objects, features and advantages of the invention will be more clearly understood from the following detailed description taken in conjunction with the accompanying drawings, in which:

FIG. 1 is a cross-sectional view of a conventional rigid flexible PCB;

FIG. 2 is an inclined view showing a rigid flexible PCB according to some embodiments;

FIG. 3 is a cross-sectional drawing for explaining the rigid flexible PCB according to some embodiments;

FIG. 4 is a drawing for explaining the plane conducting layer 113 of FIG. 3; and

FIGS. 5 to 8 are drawings showing various examples embodying the plane conducting layer of FIG. 3.

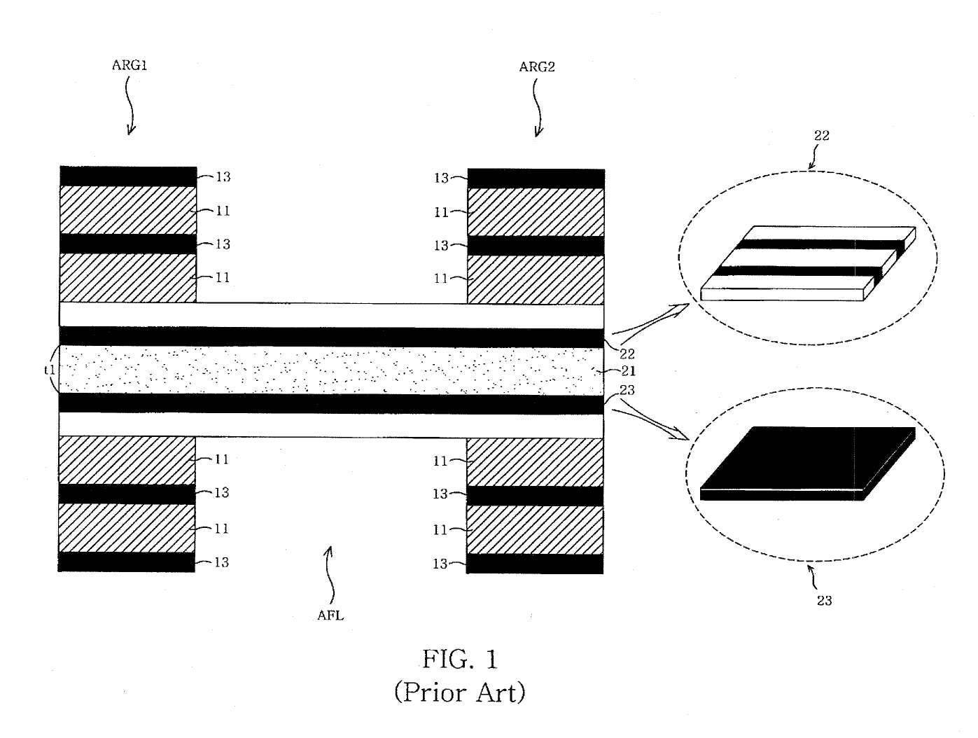

### DESCRIPTION OF THE PREFERRED EMBODIMENTS

The invention is described in detail herein by describing preferred embodiments with reference to the accompanying drawings.

In the drawings, the same reference numerals are used to designate the same or similar components. In the following description, detailed descriptions may be omitted if it is determined that the detailed descriptions of related well-known functions and construction may make the gist of the invention unclear.

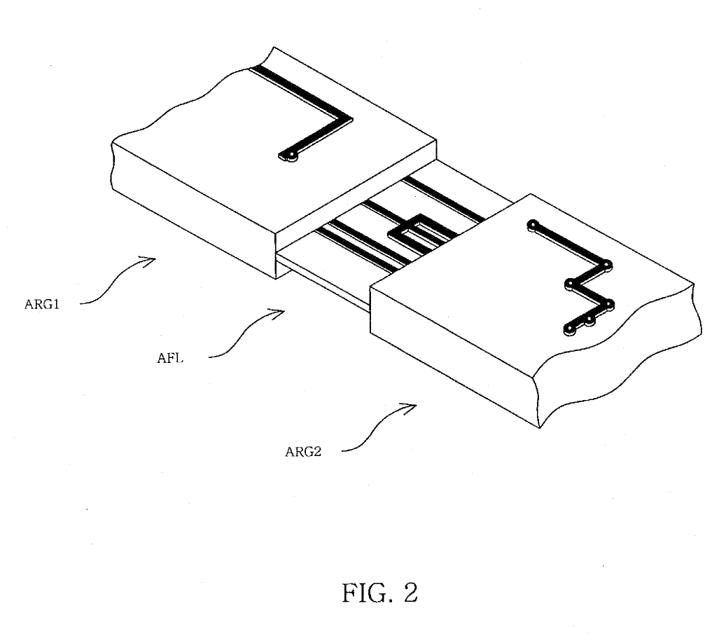

FIG. 2 is an inclined view showing a rigid flexible PCB according to some embodiments. Referring to FIG. 2, the rigid flexible PCB includes a flexible section AFL and rigid sections ARG1 and ARG2. The rigid sections ARG1 and ARG2 are formed at the edges of the flexible section AFL. The flexible section AFL is flexible, while the rigid sections ARG1 and ARG2 are mechanically stiff. Electrical signals may be transferred between the rigid sections, ARG1 and ARG2, and the flexible section AFL.

Conductive wire traces may be formed in the flexible section AFL and rigid sections ARG1, ARG2. The rigid sections ARG1, ARG2 may include holes to connect circuit components or electrical hardware together. Generally, the rigid sections ARG1, ARG2 consist of more layers than the flexible section AFL.

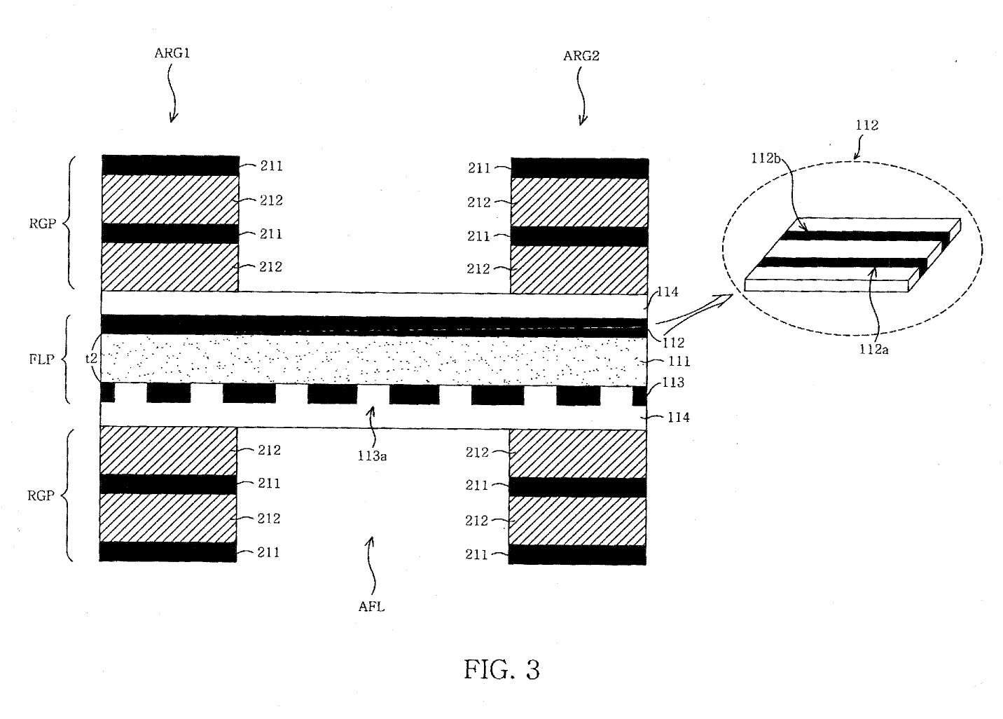

FIG. 3 is a cross sectional drawing for explaining the rigid flexible PCB according to some embodiments. In FIG. 3, the flexible section AFL and a part of the rigid sections ARG1, ARG2 are shown.

Referring to FIG. 3, a rigid flexible PCB comprises a flexible plane FLP and a rigid plane RGP. Preferably, the flexible plane FLP includes the flexible section AFL and extends into the rigid sections ARG1, ARG2. The rigid planes RGP are formed on the flexible plane FLP which is extended into the rigid sections ARG1, ARG2. It is possible however, for the flexible plane FLP not to extend into the rigid sections ARG1, ARG2, in which case the rigid sections ARG1, ARG2 are disposed adjacent to the flexible section AFL.

Referring to FIG. 3, the flexible plane FLP is implemented including a base insulating layer 111, a wire conducting layer 112 and plane conducting layer 113. The base insulating layer 111 is formed with flexible material such as polyimide.

The wire conducting layer 112 and the plane conducting layer 113 are adhered to each of the top side and the bottom side of the base insulator 111. The wire conducting layer 112 and the plane conducting layer 113 may be implemented as copper clad laminate (CCL) which is conductive. In the wire conducting layer 112, as shown, the wire traces 112a, 112b may be patterned for transferring a power voltage VCC and various signals.

The plane conducting layer 113 is used to transfer a ground voltage VSS which functions as reference voltage. On the surface of the wire conducting layer 112 and the plane conducting layer 113, a cover layer 114 is formed for protecting a flexible plane FLP.

The rigid plane RGP may be formed on the flexible plane FLP which is extended from the flexible plane AFL. The rigid plane RGP has a mechanical stiffness. Preferably, the rigid plane RGP includes multiple conducting layers 211 and prepregs 212. The conducting layers 211 are isolated from each other by the prepregs 212. And, the prepregs 212 help the rigid plane RGP to maintain a mechanical stiffness.

As shown in FIG. 3, when the flexible plane FLP is extended from the flexible section AFL into the rigid sections ARG1, ARG2, the rigid sections ARG1, ARG2 and the flexible section AFL may be connected without a separate connector. Thus, the reliability for connecting is improved.

Meanwhile, the rigid flexible PCB of the invention has a difference from the conventional rigid flexible PCB in that the plane conducting layer 113 includes openings 113a.

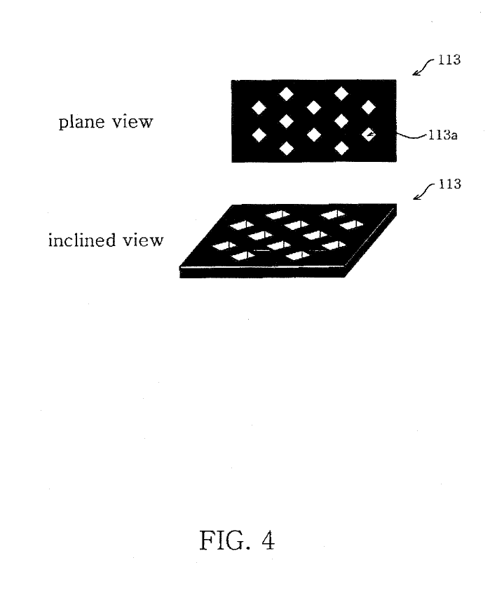

FIG. 4 is a drawing for explaining the plane conducting layer 113 of FIG. 3. As shown in FIG. 4, the plane conducting layer 113 is formed in the shape of a plane. A plurality of openings 113a are formed in the plane conducting layer 113. Thus, the characteristic impedance of signal wire traces, which are arranged in the wire conducting layer 112, may be improved.

That is to say, since the openings 113a are formed in a plane, the conducting area of the plane conducting layer 113 is decreased. In this case, the parasite capacitance between the wire conducting layer 112 and the plane conducting layer 113 is decreased. As a result, the characteristic impedance of signal wire traces, which are arranged in the wire conducting layer 112, may be controlled to be a small value.

Therefore, since the thickness t2 of the base insulating layer 111 may be thinner, the flexibility of the flexible section AFL is improved.

And, when a plurality of openings 113a are implemented in the plane conducting layer 113, the conductivity of the plane conducting layer 113 may be controlled as homogeneous. Further, when the openings 113a are implemented as a mesh structure, the conductivity of the plane conducting layer 113 becomes more homogeneous. As a result, the signals may be transferred more reliably in the PCB.

In addition, if the plane conducting layer 113 having the mesh structure is extended into the rigid sections ARG1, ARG2, the base insulating layer 111 may be thinner.

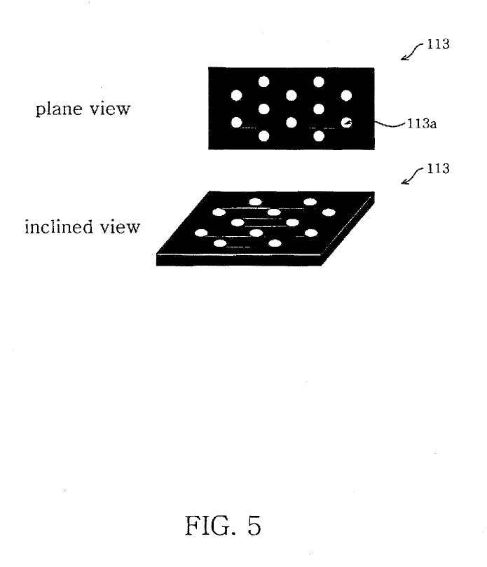

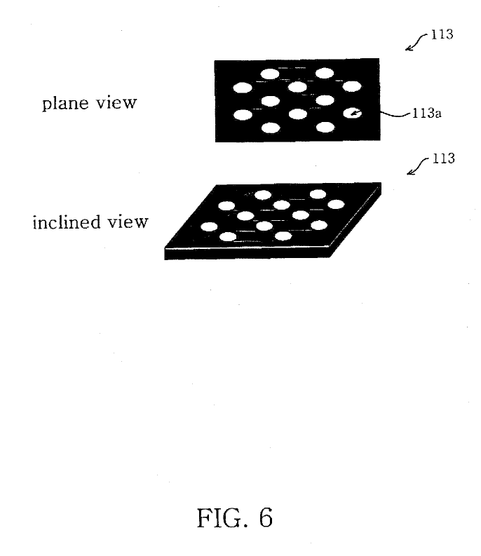

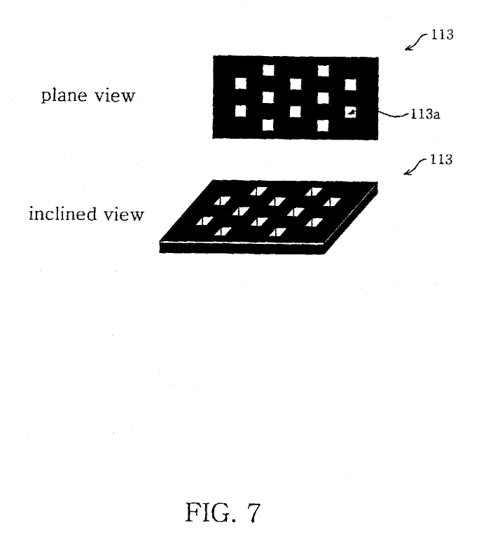

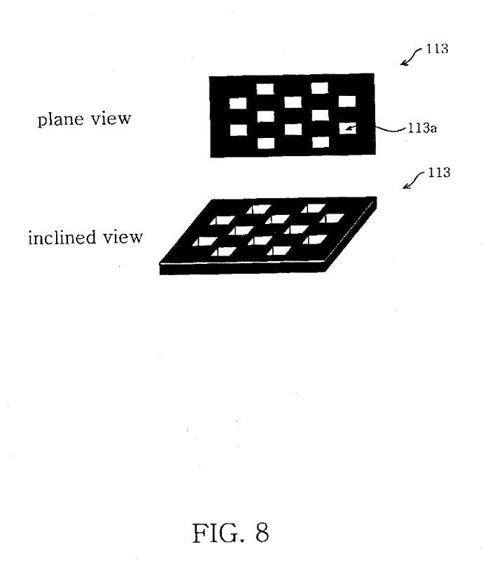

Meanwhile, the openings 113a of the plane conducting layer 113, as shown in FIGS. 5 to 8, may be embodied as various shapes such as a circle shape, an oval shape, a square shape, a rectangle shape, and/or some combination of these. Preferably, the openings 113a are formed to be diamond shapes. In this case, the homogeneity of the current may be improved.

According to the rigid flexible PCB of the invention, a plurality of openings are formed in the plane conducting layer 113. Thus, the parasitic capacitance between the wire conducting layer and the plane conducting layer is decreased. As a result, the characteristic impedance of signal wire traces, which are arranged in the wire conducting layer, may be controlled to be a small value.

Therefore, according to the rigid flexible PCB of the invention, the flexibility of the flexible section and the characteristic impedance of signal wire traces may be improved.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

For example, the embodiment that the plane conducting layer transfers the ground voltage VSS is described and drawn in this specification. However, the technical scope of the invention is realized by the embodiment that the plane conducting layer transfers the power voltage VCC. In this case, the power voltage VCC may be used as the reference voltage.

Therefore, the technical scope of the invention should be defined by the technical spirit of the accompanying claims.

What is claimed is:

1. A rigid flexible PCB (printed circuit board) comprising:
a flexible section; and
rigid sections disposed at the edges of the flexible section, wherein the flexible section comprises a flexible plane and the flexible plane comprises:
a base insulating layer;
a wire conducting layer being capable of having wire traces to transfer signals between the rigid sections, the wire conducting layer being adhered to one of the top side and the bottom side of the base insulating layer; and
a plane conducting layer adhered to the other of the top side and the bottom side of the base insulating layer, the plane conducting layer configured to transfer a reference voltage between the rigid sections,
wherein the plane conducting layer has at least one opening.

2. The rigid flexible PCB of claim 1, wherein the at least one opening is formed as one of a circle shape, an oval shape, a square shape, a rectangle shape and a diamond shape.

3. The rigid flexible PCB of claim 1, wherein the plane conducting layer has a plurality of openings.

4. The rigid flexible PCB of claim 3, wherein the plurality of openings form a mesh structure on the plane conducting layer.

5. The rigid flexible PCB of claim 1, wherein the plane conducting layer is adhered to the bottom side of the base insulating layer.

6. The rigid flexible PCB of claim 1, wherein the reference voltage is a ground voltage.

7. The rigid flexible PCB of claim 3, wherein the plurality of openings comprises at least one of a circle shape, an oval shape, a square shape, a rectangle shape and a diamond shape.

8. The rigid flexible PCB of claim 7, wherein each opening of the plurality of openings is formed as a diamond shape.

9. The rigid flexible PCB of claim 4, wherein the rigid section comprises:
a portion of the flexible plane extending from the flexible section; and
a rigid plane being formed on the flexible plane.

10. The rigid flexible PCB of claim 9, wherein the mesh structure of the plane conducting layer is extended to the rigid section.

11. The rigid flexible PCB of claim 10, wherein the rigid plane includes a prepreg.

12. The rigid flexible PCB of claim 9, wherein the rigid plane includes a multiple conducting layer.

13. The rigid flexible PCB of claim 1, wherein the base insulating layer comprises polyimide.

14. A rigid flexible PCB comprising:
a flexible plane comprising a flexible section, the flexible section including:
a base insulating layer;
a wire conducting layer; and
a plane conducting layer, wherein the plane conducting layer includes one or more openings; and
a rigid plane disposed on the flexible plane.

15. The rigid flexible PCB of claim 14, wherein each of the one or more openings is formed as at least one of a circle shape, an oval shape, a square shape, a rectangle shape and a diamond shape.

16. The rigid flexible PCB of claim 14, wherein the one or more openings form a mesh pattern on the plane conducting layer.

17. The rigid flexible PCB of claim 16, wherein the mesh pattern extends between the flexible plane and the rigid plane.

18. The rigid flexible PCB of claim 14, wherein the rigid plane comprises at least one rigid section disposed at an edge of the flexible section.

19. A rigid flexible PCB comprising:
a flexible section including:
a base insulating layer;
a wire conducting layer; and
a plane conducting layer, wherein the plane conducting layer includes one or more openings; and
a rigid section disposed at the edges of the flexible section.

20. The rigid flexible PCB of claim 19, wherein the one or more openings form a mesh pattern on the plane conducting layer.

21. The rigid flexible PCB of claim 19, wherein the wire conducting layer is disposed on a first surface of the base insulating layer and the plane conducting layer is disposed on a second surface of the base insulating layer.

22. The rigid flexible PCB of claim 19, wherein the wire conducting layer is configured to route signals and the plane conducting layer is configured to route a reference voltage.
